(19) United States
(12) Patent Application Publication
(10) Pub. No.: US 2016/0016562 A1
(43) Pub. Date: Jan. 21, 2016

(54) Controlled Creep Speed During Higher Speed Idling Such as DPF Regeneration

(71) Applicant: Caterpillar Inc., Peoria, IL (US)

(72) Inventors: James B. McKnight, Champaign, IL (US); Gene A. Townsend, Dunlap, IL (US); Dennis A. Barney, Morton, IL (US); Jesse L. Farmer, Tuscon, AZ (US)

(73) Assignee: Caterpillar Inc., Peoria, IL (US)

(21) Appl. No.: 14/335,782

(22) Filed: Jul. 18, 2014

(51) Int. Cl. B60T 8/17; B60T 7/04; F01N 3/023; B60T 8/172

(52) U.S. Cl. CPC B60T 8/1701; B60T 8/172; B60T 7/042; F01N 3/023

(57) ABSTRACT

A machine is provided where the machine includes: an engine configured to operate at an idle speed; an engine exhaust system connected to the engine; at least one service brake connected to at least one of wheels of the machine; at least one brake solenoid connected to the at least one service brake; a brake controller connected to the at least one brake solenoid and the at least one service brake; and an anti-lunging system configured to control the at least one brake solenoid during periods of higher idle speed, where the brake controller is configured to control the at least one service brake, the at least one brake solenoid and the anti-lunging system.

### TECHNICAL FIELD

The disclosure relates generally to a method and device for controlling a machine when operating at higher idling speeds, and more particularly, to a method and device for controlling a brake system of a machine when operating at higher idling speeds such as during a regeneration process.

### BACKGROUND

One of the byproducts of fuel combustion in an internal combustion engine is carbon particles, which are typically referred to as soot. Emission standards will typically specify a limit to the amount of soot that an engine can emit to the environment, which limit will be below the level of soot generated by the engine during operation. One device commonly used to limit the amount of soot expelled into the environment from an engine is referred to as a particulate trap. A commonly used particulate trap is a diesel particulate filter (DPF). However, the DPF becomes saturated with soot as the operation of the engine continues with time.

One method of restoring the performance of the DPF is a process called regeneration. Often, the regeneration is accomplished by active regeneration involving increasing a temperature of the DPF. The active regeneration is usually performed while the engine is being operated. Controlling a power train torque is desirable to carry out a stable regeneration process. An example of controlling a power train torque is disclosed in U.S. Pat. Pub. No. 2010/00185375A1 (hereafter “the '375 patent”), entitled “Acceleration Control Apparatus For Vehicle.” The '375 patent is directed generally to controlling a degree of reliability for a power-train torque during a normal vehicle operation.

However, the regeneration can cause the engine speed to increase from a low idle speed to a higher idle speed resulting in a higher torque output while the operator's foot is off a throttle pedal during the active generation. Other processes may increase the idle speed and increase torque as well. If a machine is shifted from a parked state to a driving mode either forward or reverse, the machine can lunge unexpectedly and potentially experience handling problems even at a low speed when the machine is idling at a higher speed. However, the known methods for controlling machine acceleration do not fully address the issues during higher idle speeds such as during active regeneration of a DPF in a machine. As a result, there is a need for a device and a method to stably control a machine when operating at higher idling speeds.

### SUMMARY

In accordance with one aspect of the disclosure, a machine is provided where the machine includes: an engine configured to operate at an idle speed; an engine exhaust system connected to the engine; at least one service brake connected to at least one of wheels of the machine; at least one brake solenoid connected to the at least one service brake; a brake controller connected to the at least one brake solenoid and the at least one service brake; and an anti-lunging system configured to control the at least one brake solenoid during periods of higher idle speed, where the brake controller is configured to control the at least one service brake, the at least one brake solenoid and the anti-lunging system.

In accordance with another aspect of the disclosure, a method is provided where the method includes: configuring at least one service brake to control at least one of wheels in a machine; configuring at least one solenoid brake to control a brake pressure of the at least one service brake of the machine; configuring an anti-lunging system to control the at least one service brake according to at least one of three gear maps comprising a first gear map, a second gear map, and a reverse gear map; and configuring a brake controller in the machine to control the at least one service brake, the at least one solenoid and the anti-lunging system.

In accordance with another aspect of the disclosure, a machine is disclosed where the machine includes: an engine; an after-treatment system connected to the engine, wherein the after-treatment system is configured to increase a temperature of a diesel particulate filter (DPF) in the after-treatment system during active regeneration; at least one service brake connected to at least one of wheels of the machine; at least one brake solenoid connected to the at least one service brake; anti-lunging means for controlling the at least one service brake according to at least one of three gear maps comprising a first gear map, a second gear map, and a reverse gear map during the active regeneration; and means for controlling the at least one service brake, the at least one brake solenoid and the anti-lunging means.

### BRIEF DESCRIPTION OF THE FIGURES

FIG. 1 is an illustrative, but nonlimiting example of a machine according to an aspect of the disclosure.

FIG. 2 shows an exemplary internal structure of the machine of FIG. 1.

FIG. 3 shows an example of the first gear map according to the disclosure.

FIG. 4 shows an example of the second gear map according to the disclosure.

FIG. 5 shows an example of the third gear map according to the disclosure.

FIG. 6 shows an exemplary conversion map showing a relationship between a percent brake pressure applied to a brake and an amount of electric current applied to a rear solenoid.

FIG. 7 shows exemplary information that a brake controller with an anti-lunging system processes.

### DETAILED DESCRIPTION OF THE DISCLOSURE

The particular values and configurations discussed in these non-limiting examples may be varied and are cited merely to illustrate at least one aspect and are not intended to limit the scope thereof.

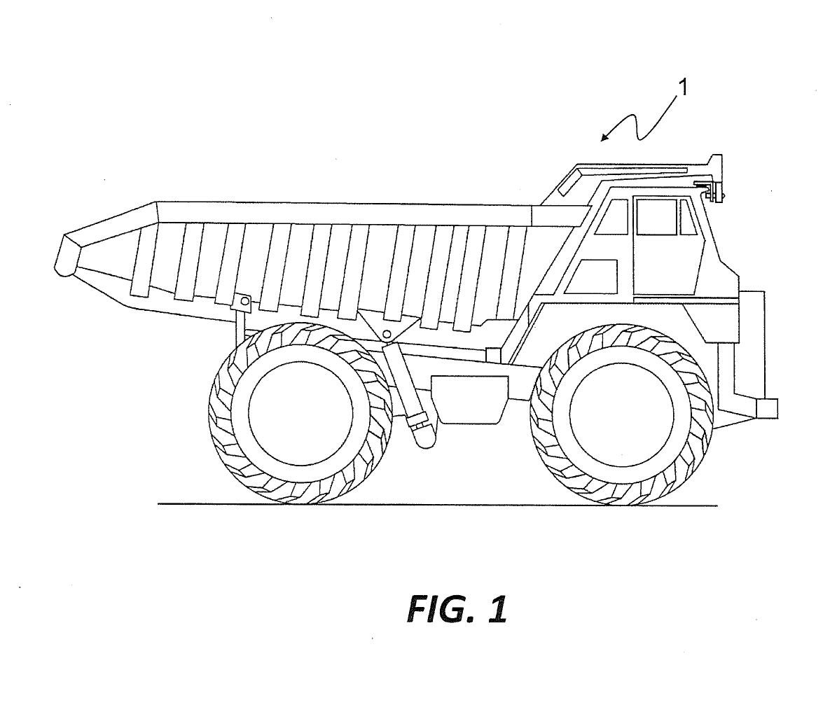

Referring to the drawings, and initially to FIG. 1, an illustrative, but nonlimiting example of Machine 1 that may be a load-hauling machine is shown. The term “machine” is used generically to describe any stationary or mobile machine. As can be appreciated, other machines may have different configurations and/or various other implements. Machine 1 illustrated in FIG. 1 may refer to any machine that performs some type of operation associated with an industry such as mining, construction, farming, transportation, or any other industry known in the art. For example, Machine 1 may be an earth-moving machine, such as a wheel loader, excavator, dump truck, backhoe, motor grader, material handlers, pavers, locomotives, tunnel boring machines, or the like. The machine 1 may include an engine, wheels, transmission, suspension system, operator cab, hydraulic system, work implements, material holding components, cooling system, fuel system, and the like.

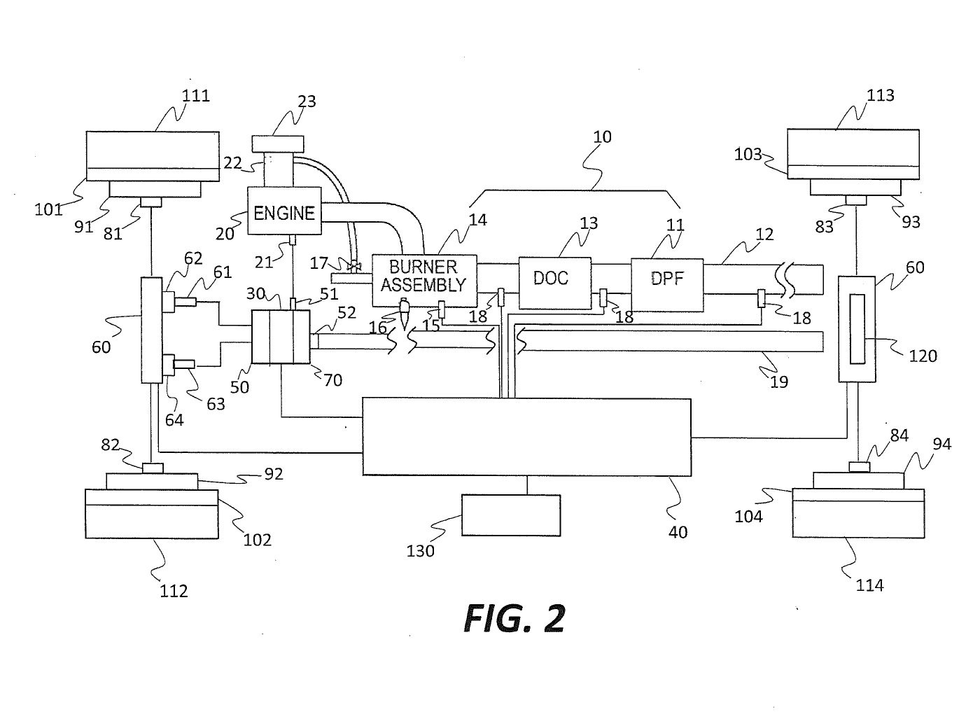

FIG. 2 shows an exemplary internal structure of Machine 1. Machine 1 may include an after-treatment system 10. The after-treatment system 10 may include devices disposed to receive a flow of exhaust gas from an engine 20. The after-treatment system 10 may additionally include one or more internal devices operating to chemically, or physically treat a flow of exhaust gas passing therethrough. The after-treatment system 10 may include a diesel particulate filter (DPF) 11, which may be included as part of the after-treatment system 10 or may be disposed as a standalone part in fluid communication with an exhaust pipe 12 of the engine 20. In some aspects, the after-treatment system 10 may alternatively or additionally include a catalytic converter, a catalyzed particulate trap, a NOₓ absorber, or any other type of after-treatment device that may be regenerated, require a rise in temperature for proper operation or require higher idle speeds.

Contaminants such as particulate matters contained in the exhaust gas may be filtered by the DPF 11, and then the trapped particulates or the like after the filtering may be removed by being combusted by an exothermic reaction of the diesel oxidation catalyst (DOC) 13, which may be provided at a front end of the DPF 11. The DPF 11 may limit the amount of soot expelled into the environment from the engine 20.

The after-treatment system 10 may be thermally regenerated. A regeneration burner 14 may be positioned anywhere along the exhaust pipe 12 between the engine 20 and the DPF 11. The regeneration burner 14 may include a fuel injector 15 configured to inject fuel into the exhaust flow, an air valve 17 connected to a compressor 22 and configured to mix pressurized air with the injected fuel, and an ignition source 16 configured to ignite the fuel mixture.

In one aspect, regeneration of the after-treatment system 10 may be accomplished by active regeneration. Active regeneration may involve increasing a temperature of the after-treatment system 10. When the soot loading in the filter reaches a set limit, the regeneration process may initiate post combustion fuel injection to increase the exhaust temperature and trigger regeneration. The active regeneration may use the regeneration burner 14 to achieve the temperatures at the catalyst required for filter regeneration. The additional heat may ensure that the excess carbon is oxidized without any operator's intervention.

Active regeneration may occur more frequently in the machine 1 at low speed, low load, or stop and go duty cycles. For example, active regeneration may occur if the after-treatment DPF restriction has reached a specified limit and if the machine 1 moves less than a threshold speed. The active regeneration may be activated and de-activated as needed.

A temperature sensor 18 may be associated with the exhaust pipe 12 and located downstream of the after-treatment system 10 to detect and communicate a temperature of the exhaust gas flow exiting the after-treatment system 10. The temperature sensor 18 may be located within or associated with the exhaust pipe 12. One skilled in the art may recognize that the temperature sensor 18 can include additional sensing elements located, for example, downstream of the after-treatment system 10 to detect and communicate exhaust gas temperature downstream of the after-treatment system 10. Additionally, additional temperature sensors 18 may be located upstream of the after-treatment system 10 to sense a temperature of the exhaust gas flow entering the after-treatment system 10.

An engine controller 30 may be associated with a drivetrain 19 and operate in response to various inputs. The engine controller 30 may embody a single microprocessor or multiple microprocessors that include various functionality for controlling the engine 20. Numerous commercially available microprocessors can perform the functions of the engine controller 30. The engine controller 30 may include all of the components required to run an application such as, for example, a memory, a secondary storage device, and a processor, such as a central processing unit or any other means known in the art for controlling the engine 20. Various other known circuits may be associated with the engine controller 30, including power supply circuitry, signal-conditioning circuitry, solenoid driver circuitry, communication circuitry, and other appropriate circuitry.

It should be appreciated that the engine controller 30 could be communicatively connected to or embedded in a general engine control module (ECM) 40 capable of controlling numerous engine functions. The ECM 40 may be associated with the after-treatment system 10. The ECM 40 may broadly encompass one or more controllers that may be associated with the machine 1 and that may cooperate in controlling various functions and operations of the machine 1 including control of a regeneration device or regeneration processes. The ECM 40 may be connected to various sensors 18 that are disposed to measure various parameters during operation of the after-treatment system 10. The ECM 40 may be connected to an injector 15 associated with the after-treatment system 10. The ECM 40 may be further connected to an engine speed module 50 and to a brake controller 60.

The engine speed module 50 may generate an engine speed signal corresponding to the rotational speed of the engine 20. The engine speed module 50 may receive a signal corresponding to a crankshaft speed or signals from one or more sensors 21 in the engine 20. The engine speed signal may also be generated from various other types of sensors including a transmission sensor, a gear position sensor, or other sensors within the machine 1. In one aspect, the engine speed module 50 may be connected to an input speed sensor 51 configured to detect an input speed to a transmission 70, and an output sensor 52 configured to detect a transmission output speed.

A throttle pedal position sensor 61 may be connected to the engine speed module 50. A throttle pedal 62 may control fuel and air supply to the machine's engine 20. The throttle pedal position sensor 61 may convert the throttle pedal movement and position into electric signals. For example, when the throttle pedal 62 is in an engine idle position where an operator's foot is off the throttle pedal 62, an output signal may be produced indicating that the throttle pedal 62 is not depressed. Conversely, when the throttle pedal 62 is depressed beyond a predetermined idle position, the throttle pedal position sensor 61 may signal that the throttle pedal 62 is away from the idle position. The engine control module 50 may control the engine operation in response to the throttle pedal 62 position.

The machine 1 may include a park brake 23, one or more brake sensors 81, 82, 83, 84, one or more brake solenoids 91, 92, 93, 94 and one or more service brakes 101, 102, 103, 104 associated with one or more wheels 111, 112, 113, 114 in the machine 1. The service brakes 101, 102, 103, 104 may act to resist rotation of the wheels 111, 112, 113, 114 and thereby to resist motion of the machine 1. The brake sensors 81, 82, 83, 84 may monitor a pre-fill state or some other conditions which indicate that at least one service brake 101, 102, 103, 104 is ready for use. The brake controller 60 may process the sensed information, compute the braking force requested, and generate a control signal to control the amount of force applied to the brakes 101, 102, 103, 104 of the machine 1. In one aspect, the brake controller 60 may be communicatively connected to the ECM 40.

The machine 1 may include a brake pedal sensor 63. The brake pedal sensor 63 may be capable of sensing the displacement of the brake pedal 64 and/or the amount of pressure applied to the brake pedal 64. The brake pedal sensor 63 may detect the position or angle of depression of the brake pedal 64. Upon receiving signals from the brake pedal sensor 63, the brake controller 60 may deliver a signal to the brake solenoids 91, 92, 93, 94. For example, upon depression of the brake pedal 64, the brake pedal sensor 63 may communicate signals indicative of the force imposed upon the brake pedal 64 by the operator to the brake controller 60. The brake controller 60, in turn, may then send electric signals and/or current to the brake solenoids 91, 92, 93, 94. The solenoids 91, 92, 93, 94 receiving the electric signals and/or current may control the brake pressure applied to the brakes 101, 102, 103, 104 as a function of the amount of electric current received.

Machine idle speed may increase when stopped to maintain proper regeneration conditions. For example, during active regeneration, the engine speed may increase from 650 rpm at a low idle condition to 1000 rpm while the operator's foot is off the throttle pedal 62. Machine idle speed may increase for other reasons as well. However, for brevity the disclosure will focus on idle speed increase due to regeneration. If the machine is shifted from a parking position to a driving position during the active regeneration, which is either forward or reverse, the machine 1 can lunge unexpectedly and potentially experience handling problems at a low speed.

An operator interface 130 may be communicatively connected to the engine speed module 50, the after-treatment system 10, the brake controller 60 and/or the ECM 40. The operator interface 130 may be arranged to provide visual and/or audio information signals to an operator of the machine 1. The operator interface 130 may include one or more operator controls, such as a manual enable or disable switch. The operator interface 130 may include a display for displaying information relative to the operational status of the after-treatment system 10. In one aspect, the operator interface 130 may further include a display for displaying information relative to the operation status of the engine speed module 50, the brake controller 60 and/or the ECM 40. In various aspects, the operator interface 130 may be integrated with a multi-functional or multi-purpose display that is arranged to interface with other system of the machine 1.

According to the disclosure, the machine 1 may further include an anti-lunging system 120. When the anti-lunging system 120 is activated, which may be automatically or may be switched according to a manual or automatic signal such as a sensed manipulation/change in state of active regeneration, the anti-lunging system 120 may control the rear brake solenoids 93, 94 as a function of Transmission Output Speed (TOS) with three gear maps: First gear map, Second gear map, and Reverse gear map. Other numbers of gear maps are contemplated as well as other types of brake control.

The anti-lunging system 120 may be communicatively connected to the brake controller 60. The anti-lunging system 120 may actuate the brake solenoids 93, 94 which can be driven and controlled by an electric signal and/or current. The anti-lunging system 120 may control the fluid pressure on the brakes 103, 104 by variably controlling electric current to the solenoids 93, 94. For example, as the electric current to the brake solenoids 93, 94 increases, the brake pressure on the wheels 113, 114 may proportionally increase. In one aspect, the anti-lunging system 120 may control the rear service brakes 103, 104 by controlling the electric current to the rear service brake solenoids 93, 94.

The brake controller 60 may control the anti-lunging system 120 in conjunction with the active regeneration. When the status of the active regeneration is on, the brake controller 60 may control the anti-lunging system 120 based on the machine state, engine speed, actual gear, transmission output speed (TOS), the TOS to % brake tables, and the % brake to brake current tables. The specific values in the TOS to % brake tables and the % brake to brake current tables may depend on a type of the machine 1. The brake controller 60 may control the brakes 101, 102, 103, 104 of the machine 1 based on the greatest signal based on the received signals. For example, if the brake controller 60 receives the greatest brake command signal from the anti-lunging system 120, the brake controller 60 may control the brakes 101, 102, 103, 104 according to the anti-lunging system 120. If the operator depresses the brake pedal 64, then the brake controller 60 may control the brakes 101, 102, 103, 104 according to the signals from the brake pedal 64.

The anti-lunging system 120 may place a deadband on the service brakes, 103, 104. In the machine 1, when the brake pedal 64 is depressed, the machine 1 decelerates due to friction braking, i.e., frictional contact of brake pads on wheel brake rotors or brake shoes on drums. The deadband may cause the brake pedal 64 to move from a rest position through a first displacement position of the service brakes 103, 104 before hydraulic brake pressure is generated to place brake pads on wheel brake rotors or drums. When the anti-lunging system 120 is operative, the brake solenoid current may be limited to a threshold current rate change so that a limited range of brake pressure is applied to the wheels 113, 114. The threshold current rate change may be in a range of from 1 to 400 mA/ms.

While the active generation is turned on, if the machine 1 increases speed to greater than a threshold TOS, the brake controller 60 may turn off the anti-lunging system 120 by sending zero current to both rear brake solenoids 93, 94. In one aspect, the threshold TOS may be 300 rpm or higher.

Conversely, if the machine 1 reduces speed to less than or equal to the threshold TOS, the brake controller 60 may reactivate the anti-lunging system 120 by applying an initial brake current to both rear brake solenoids 93, 94 until the TOS reduces speed to a range where the rear brake solenoids 93, 94 operate under the three gear maps. In one aspect, the initial brake current may be in a range of from 200 mA to 600 mA. In some aspects, the initial brake current may be in a range of from 400 mA to 500 mA.

During the active regeneration, if the operator depresses the throttle pedal 62 beyond a threshold throttle pedal position and the engine speed is greater than a maximum threshold engine speed, the brake controller 60 may deactivate the anti-lunging system 120. In one aspect, the threshold throttle pedal position may be 12% of a full depression of the throttle pedal 62. The maximum threshold engine speed may be 1050 rpm or greater. The anti-lunging system 120 may remain deactivated until the throttle pedal 62 is released to less than the threshold pedal position or a value of the threshold pedal position minus 3% hysteresis and the engine speed becomes less than a minimum threshold engine speed. In one aspect, the minimum threshold engine speed may be 1025 rpm or less.

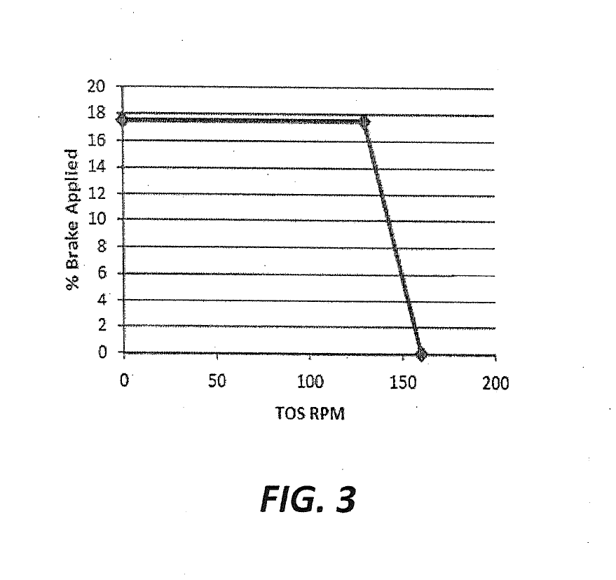

FIGS. 3, 4, and 5 show the three gear maps: the first gear, the second gear, and the reverse gear maps, respectively. During active regeneration, as the TOS slows down, the anti-lunging system 120 may control the rear brake solenoids 93, 94 under at least one of the three gear maps. The % brake pressure with respect to the full brake pressure may be retrieved as a function of TOS according to a corresponding gear map. The retrieved % brake pressure may be then multiplied by a correction factor (((engine speed)-650)/350) in order to correct for deviations in engine speed during the active regeneration. In one aspect, when the active regeneration is turned on, the correction for the deviation in engine speed may be accomplished before the engine speed has fully transitioned to an engine speed for the active regeneration. In one aspect, the correction may be accomplished before the engine speed has fully transitioned to 1000 rpm when the first regeneration goes active. If the correction factor is less than zero, the brake controller 60 may set the correction factor at zero.

Each of the three gear maps may have three threshold points. For example, when the anti-lunging system 120 controls the rear brakes 103, 104 according to the first gear map in FIG. 3, the first threshold point may be the initial brake pressure applied at 17.5% of the full brake pressure. The % brake pressure applied may remain unchanged at the initial brake pressure applied until the TOS reaches the second threshold point where the TOS is 130 rpm. As the TOS increases beyond the second threshold point, the % brake pressure applied may linearly decrease until the TOS reaches the third threshold point where the TOS is 160 rpm. At the third threshold point, the % brake pressure applied by the anti-lunging system 120 may become zero. In one aspect, the TOS at the third threshold point may always be larger than the TOS at the second threshold point. Other values of percent brake applied and associated TOS are contemplated as well. Other non-linear brake applications versus TOS are further contemplated.

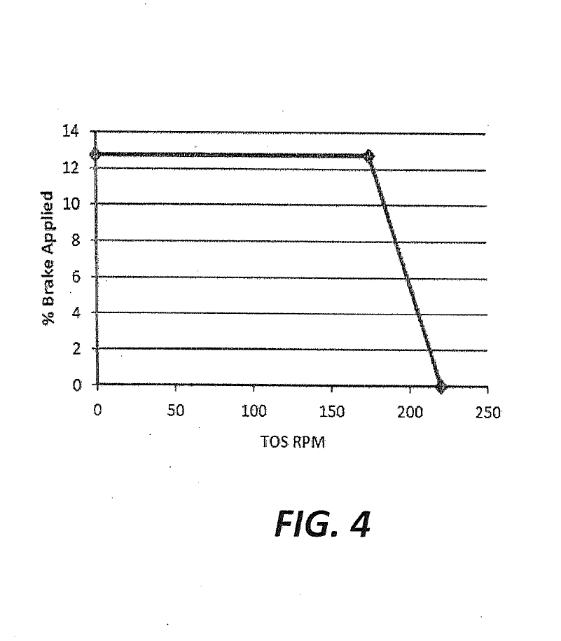

When the anti-lunging system 120 controls the brakes 103, 104 according to the second gear map in FIG. 4, the first threshold point may be the initial brake pressure applied at 12.5% of the fill brake pressure. The % brake pressure applied may remain unchanged at the initial brake pressure applied until the TOS reaches the second threshold point where the TOS is 170 rpm. As the TOS increases beyond the second threshold point, the % brake pressure applied may linearly decrease until the TOS reaches the third threshold point where the TOS is 215 rpm. At the third threshold point, the % brake pressure applied by the anti-lunging system 120 may become zero. Other values of percent brake applied and associated RPM are contemplated as well. Other non-linear brake applications versus TOS RPM are further contemplated.

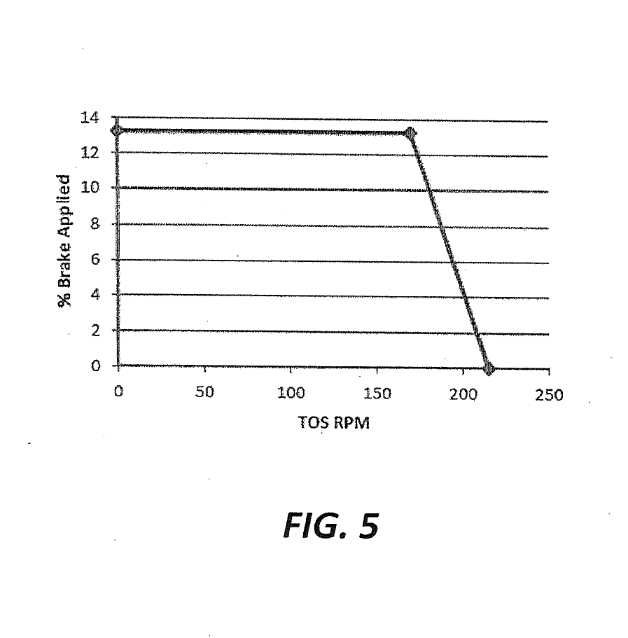

When the anti-lunging system 120 controls the brakes 103, 104 according to the reverse gear map in FIG. 5, the first threshold point may be the initial brake pressure applied at 13.25% of the full brake pressure. The % brake pressure applied may remain unchanged at the initial brake pressure applied until the TOS reaches the second threshold point where the TOS is 170 rpm. As the TOS increases beyond the second threshold point, the % brake pressure applied may linearly decrease until the TOS reaches the third threshold point where the TOS is 215 rpm. At the third threshold point, the % brake pressure applied by the anti-lunging system 120 becomes zero. Other values of percent brake applied and associated TOS are contemplated as well. Other non-linear brake applications versus TOS are further contemplated. Moreover, a single gear map may be applied to all scenarios.

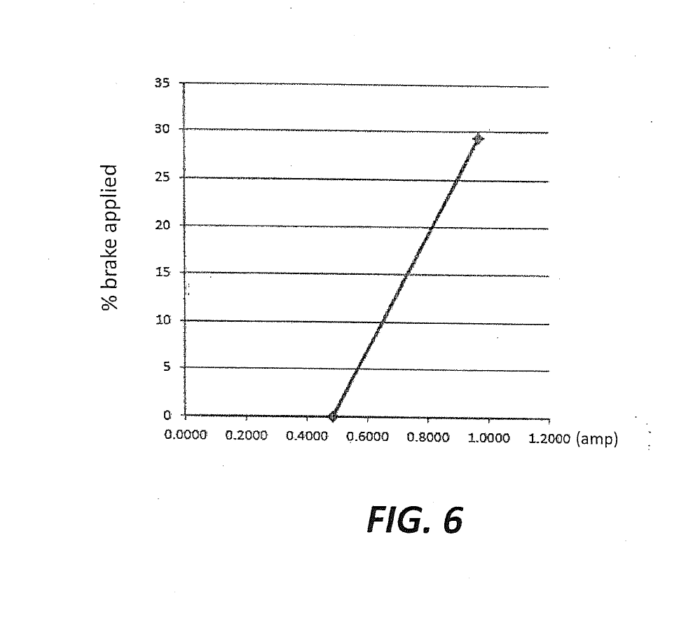

FIG. 6 shows an exemplary conversion map showing the relationship between the % brake pressure applied to the brakes 103, 104 and the amount of electric current applied to the rear solenoids 93, 94. The horizontal axis indicates an amount of current applied to the rear brakes solenoid 93, 94 and the vertical axis indicates the % brake pressure generated by the solenoids 93, 94. The specific values may depend on the type of a machine. However, the anti-lunging system 120 may limit the maximum brake current. In one aspect, the maximum brake current may be equivalent to 50% or less of the maximum brake pressure. In some aspects, the maximum brake current may be 1.2 amps or less. In various aspects, the anti-lunging system 120 may control each of the brakes 103, 104 independently.

The anti-lunging system may control the brakes 103, 104, depending on the status of the park brake 23 and/or the status of the actual gear. In one aspect, when the park brake 23 is operative during the active regeneration, the anti-lunging system 120 may apply a zero speed correction to prepare the machine 1 for movement. In some aspects, the anti-lunging system 120 may apply electric current equivalent to the first threshold point according to the first gear map in FIG. 3 or according to the first threshold point in the second gear map in FIG. 4, depending on a transmission second forward gear start feature status. If the transmission second forward gear start feature status is disabled, the anti-lunging system 120 may apply the brake current equivalent to the first threshold point according to the first gear map in FIG. 3. Conversely, if the transmission second forward gear start feature status is enabled, the anti-lunging system 120 may apply the brake solenoid current equivalent to the first threshold point in the second gear map in FIG. 4.

When the transmission is operating in first, second, or reverse gear during the active regeneration, the anti-lunging system 120 may apply the brake solenoid current based on the corresponding gear map. If the machine is moving too slow to have an appropriate speed signal, the anti-lunging system 120 may apply the brake solenoid current equivalent to the first threshold point in the corresponding gear map.

### INDUSTRIAL APPLICABILITY

The disclosure relates generally to a method and a corresponding device for controlled machine speed during periods of increased engine speed idling such as DPF regeneration. The disclosure may be applicable to any machine 1 equipped with an after-treatment system 10. Specifically, the disclosure may be applicable to a brake controller 60 with an anti-lunging system 120 that determines a desired brake pressure as a function of transmission output speed and adjusts electric current to a brake solenoid 93, 94 to obtain the desired brake pressure on a brake 103, 104 during periods of increased engine speed idling such as regeneration of the after-treatment system 10.

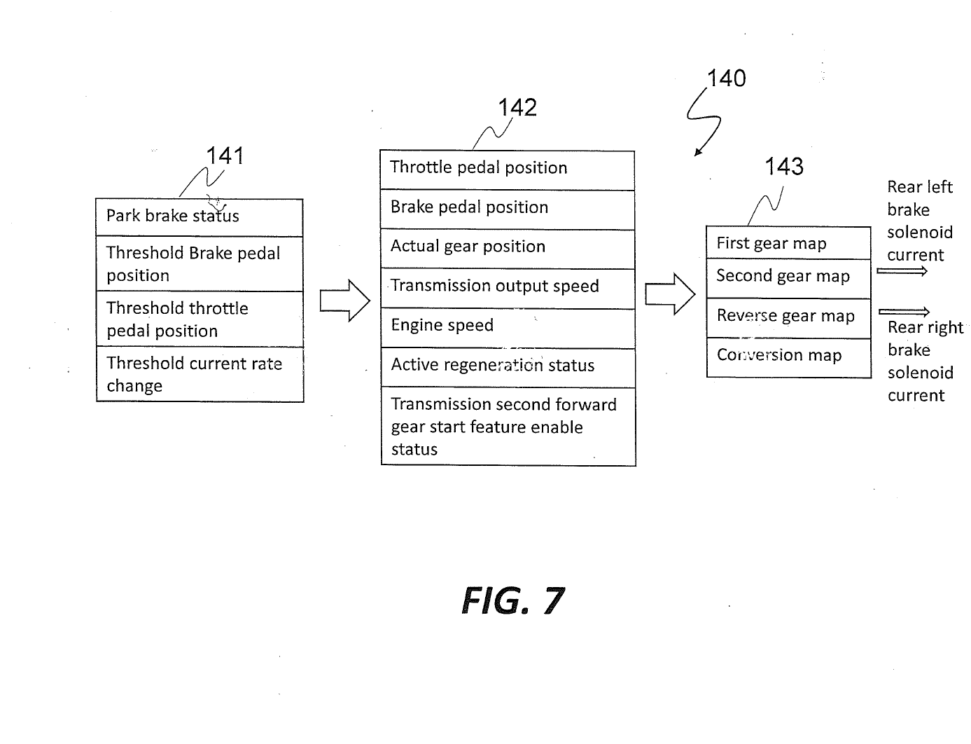

FIG. 7 shows exemplary information 140 that the brake controller 60 with the anti-lunging system 120 processes. The brake controller 60 may access input values 141 for park brake status, threshold brake pedal position, threshold throttle pedal position and threshold current rate change. The brake controller 60 may receive information 142 on throttle pedal position, brake petal position, actual gear position, transmission output speed, engine speed, active regeneration status, transmission second forward gear start feature enable status from various sensors and controllers. Based on the received information, the brake controller 60 may determine desired solenoids current according to the first gear map, second gear map, reverse gear map and conversion map 143.

The brake controller 60 may include a microcomputer including a central processing unit (CPU), a read-only memory (ROM), a random-access memory (RAM) and an interface. In one aspect, the brake controller 60 may be communicatively connected to the electronic control module (ECM) 40. The ECM 40 may include any appropriate type of general purpose microprocessor, digital signal processor, microcontroller, dedicated hardware, or the like. The ECM 40 may further include or be connected to the random access memory (RAM), the read-only memory (ROM), the storage device, the network interface and the like. The ECM 40 may execute sequences of computer program instructions to perform various processes. The computer program instructions may be loaded into the RAM for execution by the processor from the ROM, from a communication channel (wired or wireless), from the storage device and/or the like. The storage device may include any appropriate type of storage provided to store any type of information that the control device may need to perform the processing.

Random access memory (RAM) may store various digital files including the values sensed by the sensor 18. The RAM can be any suitable computer-readable medium. Examples of RAM include, but are not limited to, dynamic random access memory (DRAM), static random access memory (SRAM), ferroelectric random access memory (FRAM), resistive random access memory (RRAM), and diode memory among others. The RAM may provide the sensed values to the processor so that the processor can determine the ground property or type based on the values. The RAM can also store the determined ground condition.

The read-only memory (ROM) may store various digital files. Examples of ROM include, but are not limited to, programmable read-only memory (PROM), erasable programmable read-only memory (EPROM), electrically erasable programmable read-only memory (EEPROM), which includes electrically alterable read-only memory (EAROM) and flash memory, and optical storage, such as CD-ROMs. The RAM and/or ROM may store the algorithm the processor uses to calculate the ground property and type.

The disclosure is applicable to machines that incorporate a multi-speed transmission. For example, the disclosure may be incorporated in trucks and other heavy construction and mining machines requiring certain gearing requirements met by the disclosure. It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitations as to the scope of the disclosure generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods describe herein can be performed in any suitable order unless otherwise indicated herein or otherwise clearly contradicted by context.

Accordingly, it will be apparent to those skilled in the art that various modifications and variations can be made in the disclosed transmission assemblies without departing from the scope of the disclosure. Other embodiments of the disclosed transmission will be apparent to those skilled in the art from consideration of the specification and practice of the transmission disclosed herein. It is intended that the specification and examples be considered as exemplary only, with a true scope of the disclosure being indicated by the following claims and their equivalents.

We claim:

1. A machine, comprising:
an engine configured to operate at an idle speed;
an engine exhaust system connected to the engine;
at least one service brake connected to at least one of wheels of the machine;
at least one brake solenoid connected to the at least one service brake;
a brake controller connected to the at least one brake solenoid and the at least one service brake; and
an anti-lunging system configured to control the at least one brake solenoid during periods of higher idle speed,
wherein the brake controller is configured to control the at least one service brake, the at least one brake solenoid and the anti-lunging system.

2. The machine according claim 1, further comprising:
an after-treatment system connected to the engine exhaust system, wherein the after-treatment system is configured to carry out active regeneration.

3. The machine according to claim 2, wherein the after-treatment system comprises a diesel particulate filter (DPF), where the after-treatment system is further configured to increase a temperature of the DPF during the active regeneration.

4. The machine according to claim 2, wherein the anti-lunging system is further configured to apply an initial electric current to the at least one brake solenoid when the active regeneration becomes active.

5. The machine according to claim 1, wherein the at least one brake solenoid is configured to control a brake pressure on the at least one service brake as a function of an amount of the electric current.

6. The machine according to claim 1, wherein the anti-lunging system is further configured to place a deadband on the at least one service brake.

7. The machine according to claim 1, wherein the anti-lunging system is further configured to control a brake pressure on the at least one service brake as a function of transmission output speed (TOS) of the machine with a conversion map and at least one of three gear maps comprising a first gear map, a second gear map, and a reverse gear map.

8. The machine according to claim 7, wherein the anti-lunging system is further configured to linearly decrease the brake pressure according to at least one of the three gear maps as the transmission output speed (TOS) increases.

9. The machine according to claim 1, wherein the brake controller is further configured to deactivate the anti-lunging system when the machine speeds up to greater than a threshold transmission output speed during the active regeneration.

10. The machine according to claim 1, further comprising
a brake pedal connected to the brake controller;
a brake pedal sensor connected to the brake pedal and configured to measure a brake pedal position;
a throttle pedal operatively connected to the engine; and
a throttle pedal sensor connected to the throttle pedal and configured to measure a throttle pedal position,
wherein the brake controller is communicatively connected to the brake pedal sensor and to the throttle pedal sensor in the machine.

11. The machine according to claim 10, wherein the brake controller is configured to control the anti-lunging system as a function of the brake pedal position during the active regeneration.

12. The machine according to claim 10, wherein the brake controller is configured to control the anti-lunging system as a function of the throttle pedal position during the active regeneration.

13. The machine according to claim 12, wherein the brake controller is configured to deactivate the anti-lunging system when the threshold throttle pedal position is greater than a threshold throttle pedal position and an engine speed is greater than a maximum threshold engine speed.

14. The machine according to claim 11, wherein the threshold throttle pedal position is 12% of a full depression of the throttle pedal and the maximum threshold engine speed is 1050 rpm.

15. The machine according to claim 1, wherein the anti-lunging system is configured to apply 1.2 amps or less of electric current to the at least one brake solenoid.

16. A method, comprising:
configuring at least one service brake to control at least one of wheels in a machine;
configuring at least one solenoid brake to control a brake pressure of the at least one service brake of the machine;
configuring an anti-lunging system to control the at least one service brake according to at least one of three gear maps comprising a first gear map, a second gear map, and a reverse gear map; and
configuring a brake controller in the machine to control the at least one service brake, the at least one solenoid and the anti-lunging system.

17. The method according to claim 16, further comprising:
configuring an after-treatment system in the machine to control active regeneration;
configuring the after-treatment system to increase a temperature of a diesel particulate filter (DPF) in the after-treatment system during the active regeneration;
configuring the anti-lunging system to place a deadband on the at least one service brake;
configuring the anti-lunging system to control the brake pressure on the least one service brake as a function of transmission output speed (TOS) of the machine with a conversion map and the at least one of the three gear maps;
configuring the anti-lunging system to linearly decrease a brake pressure on the at least one service brake as the TOS increases according to the at least one of the three maps; and
configuring the brake controller to deactivate the anti-lunging system when the machine speeds up to a greater than a threshold transmission output speed during the active regeneration.

18. The method according to claim 17, further comprising:
configuring the brake controller to control the anti-lunging system as a function of a brake pedal position of a brake pedal operatively connected to the at least one service brake during the active regeneration; and
configuring the brake controller to control the anti-lunging system as a function of a throttle pedal position of a throttle pedal operatively connected to an engine of the machine during the active regeneration.

19. A machine, comprising:
an engine;
an after-treatment system connected to the engine, wherein the after-treatment system is configured to increase a temperature of a diesel particulate filter (DPF) in the after-treatment system during active regeneration;
at least one service brake connected to at least one of wheels of the machine;
at least one brake solenoid connected to the at least one service brake;
anti-lunging means for controlling the at least one service brake according to at least one of three gear maps comprising a first gear map, a second gear map, and a reverse gear map during the active regeneration; and
means for controlling the at least one service brake, the at least one brake solenoid and the anti-lunging means.

20. The machine according to claim 19, wherein the anti-lunging means are configured to:
place a deadband on the at least one service brake;
control a brake pressure on the least one service brake as a function of transmission output speed (TOS) of the machine with a conversion map and at least one of the three gear maps; and
linearly decrease a brake pressure on the at least one service brake according to the at least one of the three gear maps as the TOS increases.
